(19) United States
(12) Patent Application Publication
(10) Pub. No.: US 2014/0098741 A1
(43) Pub. Date: Apr. 10, 2014

(54) Indoor and Outdoor 700 MHz or 4G LTE Fabric Wi-Fi Non Mesh and Non Relay Enterprise Private Network Wi-Fi Solution

(71) Applicant: Crystal Anne Joyce, Powell, OH (US)

(72) Inventor: Crystal Anne Joyce, Powell, OH (US)

(21) Appl. No.: 13/646,676

(22) Filed: Oct. 6, 2012

(51) Int. Cl. H04W 16/00

(52) U.S. Cl. 370/328

(57) ABSTRACT

The 4G LTE Fabric WI-FI network solution provides a secure, Wi-Fi private networking solution for indoor, outdoor, and multi-location deployments. The “Fabric” Wi-Fi solution improves on the legacy mesh or web Wi-Fi networks used today, by eliminating relay latency that is experienced due to the recognized degradation of the internet signal which is distributed from the centralized hub, connected to the internet. The signal hops between wireless access points that extend away from the hub and the single point of entry for the internet signal. The 4G LTE Fabric Wi-Fi network solution integrates with the cellular 4G LTE network by installing a 4G LTE modem/network card in each individual wireless access point, providing independent point to point internet access. Networked by a hosted cloud based controller system, the network is managed remotely, providing Wi-Fi coverage that becomes scalable, more stable, increases network capacity, and provides multiple layers of redundancy.

The 4G LTE Fabric Wi-Fi network solution provides a secure, Wi-Fi private networking solution for businesses and individuals. The solution eliminates relay latency that is experienced with legacy Wi-Fi mesh or web solutions. The solution integrates the cellular 4G LTE network by installing a 4G LTE modem/network card in each individual wireless access point providing point to point internet access. Managed by a hosted controller system, the network is managed remotely to provide Wi-Fi coverage that becomes more stable, increases network capacity, and provides layers of redundancy.

### BACKGROUND OF THE INVENTION

The improvement on the configuration and deployment of the legacy Wi-Fi mesh solutions is experienced due to the elimination of the mesh network concept, which is designed to deploy a Wi-Fi network with the internet access brought into the center of the network. The legacy mesh network concept is designed to strategically place access points around the hub similar to a spider's web, building the network out ring by ring while intersecting the connections between the access points as the network expands. The internet access is shared between all of the access points by passing the signal off or relaying the signal from the center of the network, to the outer ring of the network, hopping or relay from access point to access point. This allows the wireless network to expand the coverage area, while using the limited source of internet access. This design recognizes the more hops the internet traveled, the more the users would experience latency or degraded service, dead spots with no signal, or potential limitations on throughput. In addition, this legacy mesh design has a single point of failure if there is an interruption of service to the hub at the center of the legacy mesh network.

With the 4G LTE Fabric Wi-Fi solution, the network is no longer built using hops between the access points to broadcast the internet signal, via Wi-Fi access points in the legacy mesh network. The 4G LTE Fabric Wi-Fi solution is designed to work with each individual access point having its own internet connection, with an embedded 4G LTE modem (4G LTE card or modem) installed in the access point. The access points independently connect into the 4G LTE cell/data network for the signal that they distribute. The access points are then configured and managed via the hosted, remote network controller system. The configuration of the access points allows them to pass traffic and bad balance/off bad excess traffic to neighboring access points, which allows the Wi-Fi user to have the ability to walk within the 4G LTE Fabric Wi-Fi network and not experience any degradation in service. The 4G LTE Fabric Wi-Fi network blankets the area of the network because the access points are not relaying a single internet signal. The 4G LTE Fabric Wi-Fi network is no longer limited in how far it can go from the hub, because there is no longer a hub at the center of the network providing the internet signal. This gives the ability to scale the network to fit the needs of the users. With the 4G LTE Fabric network stability built into the design, because the cellular network that distributes the 4G LTE data signal to the embedded modems in the access points, is built with redundancy in place, and the ability to hand off the signal and load balance between cell sites, to optimize the service provided. The 4G LTE capitalizes on this inherent redundancy, which means that if a modem is receiving the signal from a cell tower that goes down, the seamless handoff of the signal is made to strategically located cell towers, which allows the signal to remain uninterrupted to the specific access points. The relay capability can be configured on the access points, in case the access point loses the 4G LTE signal to the access point due to a failure of the modem. This allows the access point to receive the signal from a neighboring access point. This adds another layer of redundancy into the 4G LTE Fabric Wi-Fi network, increasing stability and suppressing degradation of service.

The 4G LTE Fabric Wi-Fi network is able to extend the Wi-Fi signal without the need to order and install internet access, which allows the blanket coverage to include hard reaching places that would not have been covered in the legacy mesh solutions. The 4G LTE Fabric Wi-Fi solution supports sustainability by reducing the materials required for deployment, through the elimination of the cat6 cables or Ethernet cables to the individual access points.

1. I claim that the 4G LTE Fabric Wi-Fi network solution provides enhanced Wi-Fi network coverage by blanketing or spreading out the “Fabric” network across the designated coverage area with the internet access inherent to each wireless access point containing a 4G LTE modem/network card, utilizing a hosted cloud based network controller to provide a seamless network that broadcasts a consistent, non-degraded Wi-Fi signal which drastically improves upon today's legacy mesh or webbed Wi-Fi network that is deployed with the understanding that the internet access signal will become degraded and users will experience latency as it hops from access point to access point to extend the size of the mesh network that contains limited internet access connected to the hub in the center of the design.

2. I claim that the 4G LTE Fabric Wi-Fi network solution's “Fabric” or blanket coverage as referenced in claim 1, provides “degradation suppression” by eliminating the degraded distribution of the internet signal, traditionally experienced in legacy mesh Wi-Fi networks due to the relaying of the incoming internet access to multiple access points that broadcast the internet signal to the edge of the network.

3. I claim that the 4G LTE Fabric Wi-Fi network solution provides enhanced redundancy, through the utilization of the Cellular service provider's 4G LTE data network, which is built to provide overlapping coverage to support and maintain a contiguous network for the cellular clients, which eliminates the risk of a single point of failure for the internet access that is broadcasted throughout the network coverage area.

4. I claim the stability of the 4G LTE Fabric Wi-Fi network solution's stability is reinforced by the redundancy provided through configuring the access points for load balancing and failover capabilities between each access points.

5. I claim that the 4G LTE Fabric Wi-Fi network solution provides a completely scalable network, able to expand immediately and without the constraints of cabled internet access, while maintaining the consistency and strength of the internet access which is broadcast via the wireless access points that contain the 4G LTE modem/network cards.

6. I claim that the 4G LTE Fabric Wi-Fi network solution is a sustainable technology solution that reduces construction waste when building, by eliminating the materials and cat6 cables that are no longer required to provide internet access to the access points which contain the 4G LTE modem/network cards, acting as independent internet access sources.

7. I claim that the 4G LTE Fabric Wi-Fi network solution is a green technology solution that provides complete portability, allowing the user to relocate the network configured wireless access points that contain the 4G LTE modem/network cards, power them up in range of the 4G LTE cellular/data provider and begin broadcasting the signal, providing instant Wi-Fi network access while maintaining the original corporate network settings.

8. I claim the 4G LTE Fabric Wi-Fi network solution is a plug and play network solution that is ready to use as soon as it is powered up and in range of the 4G LTE cellular/data network.
